(19) United States
(12) Patent Application Publication
(10) Pub. No.: US 2021/0107267 A1
(43) Pub. Date: Apr. 15, 2021

(54) THREE-DIMENSIONAL (3D) ARTICLE INCLUDING BOTH A SOLID PORTION AND A FOLDING PAPER PORTION AND METHOD OF MAKING SAME

(71) Applicant: Felix Semper, Greensboro, NC (US)

(72) Inventor: Felix Semper, Greensboro, NC (US)

(21) Appl. No.: 16/601,083

(22) Filed: Oct. 14, 2019

(51) Int. Cl. B32B 29/00; B29C 64/147; B32B 37/12

(52) U.S. Cl. CPC B32B 29/005; B33Y 80/00; B32B 37/12; B29C 64/147

(57) ABSTRACT

A three-dimensional (3D) article including both a solid portion and a folding paper portion and method of making same is disclosed. For example, a 3D article includes one or more solid portions and one or more folding paper portions. The solid portions of the 3D article may be, for example, any solid material used in sculpture applications, such as, but not limited to, clay, plaster, stone, wood, plastic, glass, and the like. The folding paper portions of the 3D article may be, for example, glued layers of paper, sliced wood, books, recycled materials, and the like. Further, a method is provided of making stretchable and flexible 3D articles that include one or more solid portions and at least one folding paper portion.

### TECHNICAL FIELD

The presently disclosed subject matter relates generally to media for creating sculptures and more particularly to a three-dimensional (3D) article including both a solid portion and a folding paper portion and method of making same.

### BACKGROUND

Paper folding methods typically require great skill and involve a series of steps that must be followed in a predetermined order to produce the desired 2D or 3D structure. These steps are difficult to elucidate for one who desires to fold a particular piece of paper into a given structure. Where multiple folds are required, it may be unclear as to which folds should be made and in what order. Yet another challenge arises where an individual may wish to produce a unique pattern or sculpture. In this case, an individual may not possess the skill to elucidate the proper series of folds that should be made to achieve the desired product.

### SUMMARY

In some aspects, the presently disclosed subject matter provides a three-dimensional (3D) article comprising one or more solid portions and one or more folding paper portions, wherein the one or more solid portions and the one or more folding paper portions are operably attached to form a stretchable and/or flexible 3D article.

In certain aspects, the one or more solid portions and the one or more folding paper portions are arranged in a vertical stack. In other aspects, the one or more solid portions and the one or more folding paper portions are arranged in a horizontal stack. In yet other aspects, the one or more solid portions and the one or more folding paper portions are arranged in both a vertical stack and a horizontal stack.

In certain aspects, the article has a closed or unstretched configuration. In such aspects, the article can have an appearance of a sculpture. In other aspects, the article has an open or stretched configuration. In particular aspects, the article can be opened or retracted with a fluid movement.

In certain aspects, the article comprises a lower solid portion and an upper solid portion with a folding paper portion sandwiched therebetween. In such aspects, the lower solid portion represents a bust of a sculpture and the upper solid portion represents a head of a sculpture.

In certain aspects, the one or more solid portions comprises a material selected from clay, plaster, stone, wood, metal, glass, ceramic, plastic, and combinations thereof. In certain aspects, the one or more paper portions comprise a material selected from paper, sliced wood, a book, one or more recycled materials, and combinations thereof.

In certain aspects, the one or more solid portions and one or more paper portions are operably attached by an adhesive.

Certain aspects of the presently disclosed subject matter having been stated hereinabove, which are addressed in whole or in part by the presently disclosed subject matter, other aspects will become evident as the description proceeds when taken in connection with the accompanying Examples and Drawings as best described herein below.

### BRIEF DESCRIPTION OF THE DRAWINGS

Having thus described the presently disclosed subject matter in general terms, reference will now be made to the accompanying drawings, which are not necessarily drawn to scale, and wherein:

FIG. 1 illustrates a side view of an example of the presently disclosed 3D article including both a solid portion and a folding paper portion in the unstretched or “closed” state;

FIG. 2 illustrates a side view of an example of the presently disclosed 3D article including both a solid portion and a folding paper portion in the stretched or “open” state;

FIG. 3 illustrates various views of stretchable paper, which is an example, of the folding paper portion of the presently disclosed 3D article;

FIG. 4 illustrates a side view of an example of a 3D flexible structure according to a simplest configuration for forming the presently disclosed 3D article;

FIG. 5A, FIG. 5B, FIG. 5C, and FIG. 5D illustrate side views of examples of 3D flexible structures that include a plurality of solid portions and a plurality of folding paper portions arranged in a vertical stack for forming the presently disclosed 3D article;

FIG. 6 illustrates a side view of an example of a 3D flexible structure that includes a plurality of solid portions and a plurality of folding paper portions arranged in a horizontal stack for forming the presently disclosed 3D article;

FIG. 7 illustrates a side view of an example of a 3D flexible structure that includes a plurality of solid portions and a plurality of folding paper portions arranged in both a vertical stack and a horizontal stack for forming the presently disclosed 3D article; and

FIG. 8 illustrates a flow diagram of an example of a method of making stretchable and flexible 3D articles that include one or more solid portions and at least one folding paper portion.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a three-dimensional (3D) article including both a solid portion and a folding paper portion and method of making same.

In some embodiments, the presently disclosed 3D article is a stretchable and flexible 3D article that includes one or more solid portions and at least one folding paper portion and wherein the folding paper portion comprises layers of paper, wood, such as thinly sliced wood, books, recycled materials, and the like, attached or adhered to one another, such as with a glue or other adhesive.

In some embodiments, the presently disclosed 3D article includes one or more solid portions and/or at least one folding paper portion to form a stretchable and flexible 3D article.

In some embodiments, the presently disclosed 3D article includes one or more solid portions and one or more folding paper portions arranged in a vertical stack to form a stretchable and flexible 3D article.

In some embodiments, the presently disclosed 3D article includes one or more solid portions and one or more folding paper portions arranged in a horizontal stack to form a stretchable and flexible 3D article.

In some embodiments, the presently disclosed 3D article includes one or more solid portions and one or more folding paper portions arranged in both a vertical stack and a horizontal stack to form a stretchable and flexible 3D article.

Additionally, a method is provided of making the presently disclosed stretchable and flexible 3D article that includes one or more solid portions and at least one folding paper portion.

In some embodiments, the presently disclosed 3D article that includes one or more solid portions and at least one folding paper portion is in the unstretched or “closed” state and provides the appearance of a solid sculpture (e.g., a stone, wood, metal, or ceramic sculpture, such as a sculpture made from clay, alabaster, ivory, jade, marble, terracotta, and the like, or any other solid material sculpture).

In some embodiments, the presently disclosed 3D article includes one or more solid portions and at least one folding paper portion that is in the stretched or “open” state, thereby providing an accordion effect that can be stretched, twisted, elongated, and retracted with fluid movement.

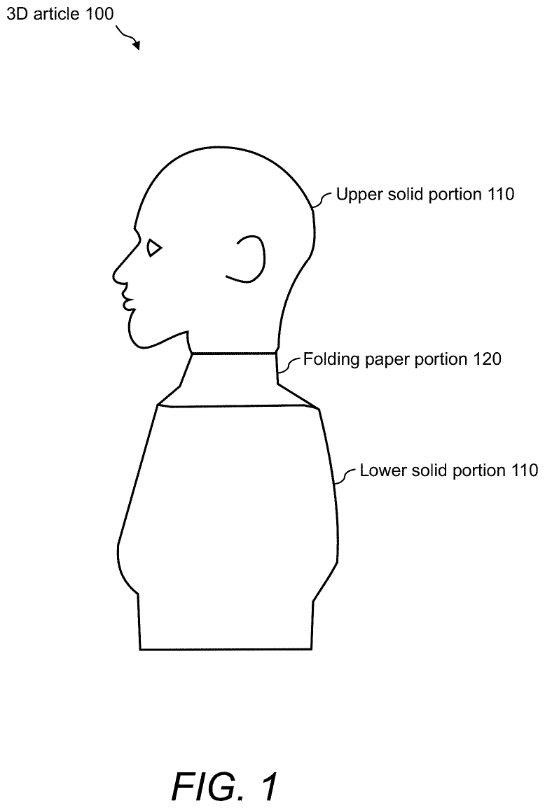

Referring now to FIG. 1 is a side view of an example of the presently disclosed 3D article 100 including both a solid portion and a folding paper portion in the unstretched or “closed” state. In this example, 3D article 100 includes a lower solid portion 110 and an upper solid portion 110 with a folding paper portion 120 sandwiched therebetween. In this example, 3D article 100 is the bust of a person wherein lower solid portion 110 is the torso of the person, upper solid portion 110 is the head of the person, and folding paper portion 120 is the neck of the person. Solid portions 110 may be any solid material used in sculpture applications, such as, but not limited to, clay, plaster, stone, wood, and the like. Folding paper portion 120 may be formed, for example, of layers of paper, sliced wood, books, recycled materials, and the like, wherein each layer is attached or adhered to one another by a glue or other adhesive material.

While FIG. 1 shows 3D article 100 as a sculpture of the bust of a person, this is exemplary only. 3D article 100 may be, for example, a sculpture of anything and may include any configuration of one or more solid portions 110 and one or more folding paper portions 120. In one example, solid portions 110 of 3D article 100 may be sculptured articles. In another example, solid portions 110 may be any solid articles, such as, but not limited to, molded plastic articles, molded glass articles, molded metal articles, and/or any other solid material articles.

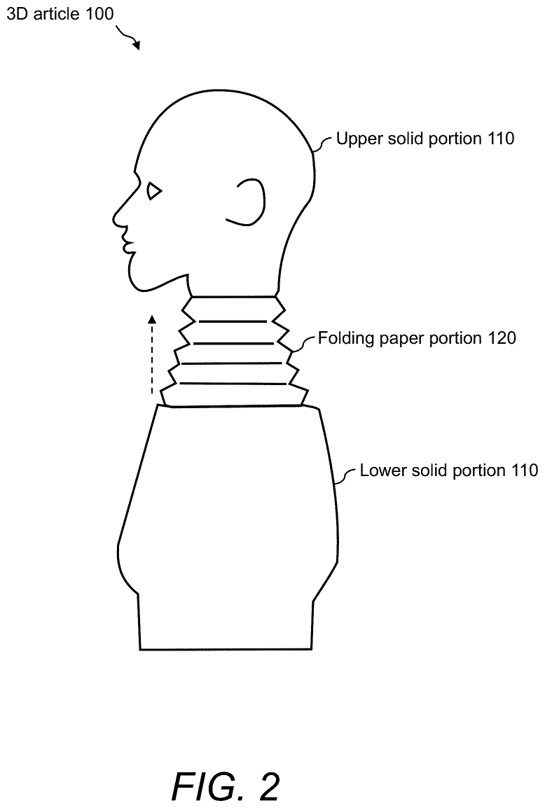

The unstretched or “closed” state means that folding paper portion 120 of 3D article 100 is in the compressed or unstretched condition. The unstretched or “closed” state provides the appearance of a solid 3D article 100. By contrast, FIG. 2 is a side view of an example of the presently disclosed 3D article 100 in the stretched or “open” state. The stretched or “open” state means that folding paper portion 120 of 3D article 100 is stretched out accordion style. That is, with fluid movement, folding paper portion 120 of 3D article 100 can be stretched, twisted, elongated, retracted, and the like. This fluid movement gives the article a playful mobility as opposed to the traditional aesthetic.

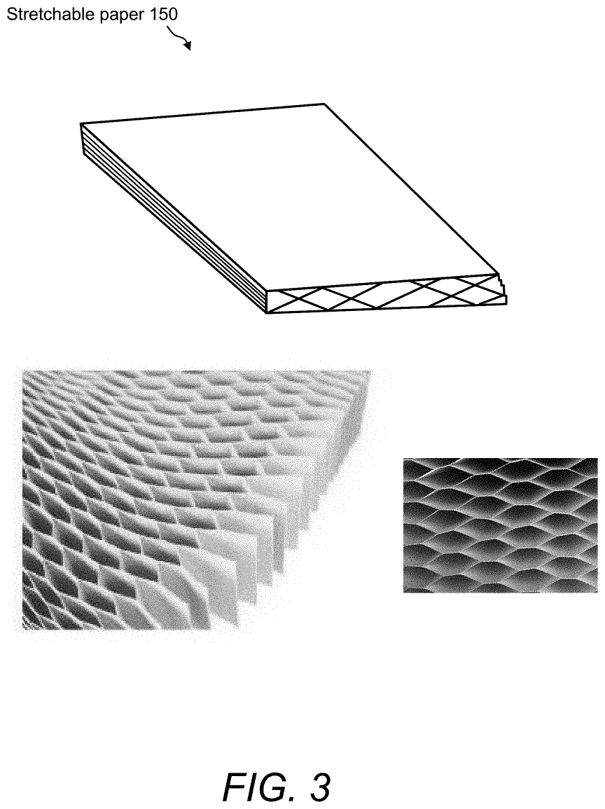

Referring now to FIG. 3 is various views of stretchable paper 150, which is an example of folding paper portion 120 of the presently disclosed 3D article 100. Stretchable paper 150 may be formed, for example, of layers of paper, sliced wood, books, recycled materials, and the like, wherein each layer is attached or adhered to one another by a glue or other adhesive material.

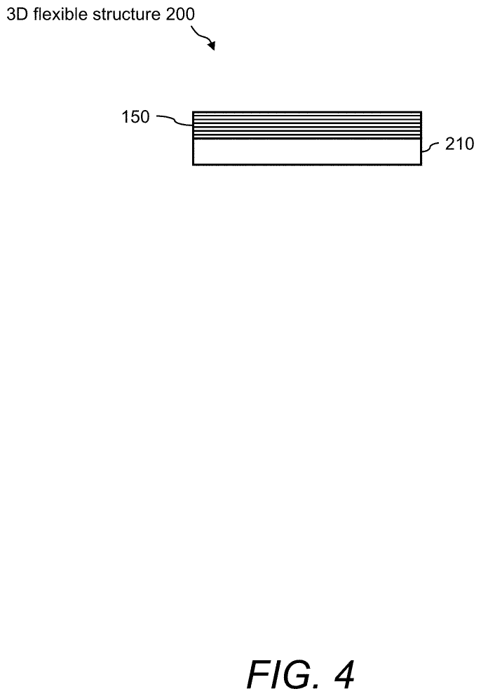

Referring now to FIG. 4 is a side view of an example of a 3D flexible structure 200 according to a simplest configuration for forming a stretchable and flexible 3D article, such as 3D article 100. That is, 3D flexible structure 200 includes one segment of stretchable paper 150 and one layer of solid material 210. Solid material 210 may be any solid material used in sculpture applications, such as, but not limited to, clay, plaster, stone, wood, and the like. In another example, solid material 210 may be any solid material, such as, but not limited to, molded plastic material, molded glass material, molded metal material, and/or any other solid material articles.

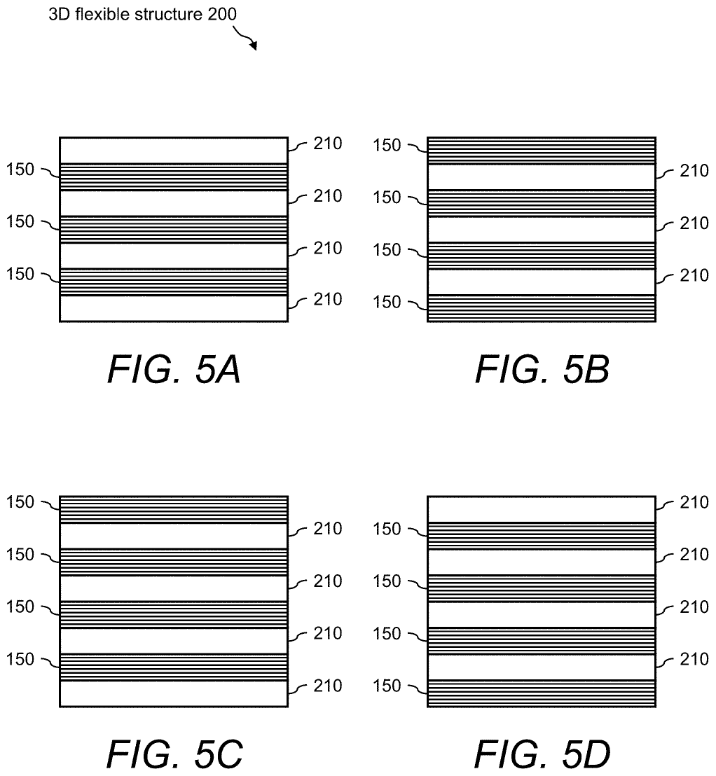

Referring now to FIG. 5A, FIG. 5B, FIG. 5C, and FIG. 5D is side views of examples of 3D flexible structures 200 that includes one or more solid portions and at least one folding paper portion arranged in a vertical stack for forming a stretchable and flexible 3D article, such as 3D article 100. For example, FIG. 5A shows a vertical alternating stack of at least one segments of stretchable paper 150 and at least one layer of solid material 210 and wherein this structure begins and ends with a layer of solid material 210. FIG. 5B shows a vertical alternating stack of at least one segments of stretchable paper 150 and at least one layer of solid material 210 and wherein this structure begins and ends with a segment of stretchable paper 150. FIG. 5C shows a vertical alternating stack of at least one segments of stretchable paper 150 and at least one layer of solid material 210 and wherein this structure begins (at the bottom) with a layer of solid material 210 and ends with a segment of stretchable paper 150. FIG. 5D shows a vertical alternating stack of at least one segments of stretchable paper 150 and at least one layer of solid material 210 and wherein this structure begins (at the bottom) with a segment of stretchable paper 150 and ends with a layer of solid material 210.

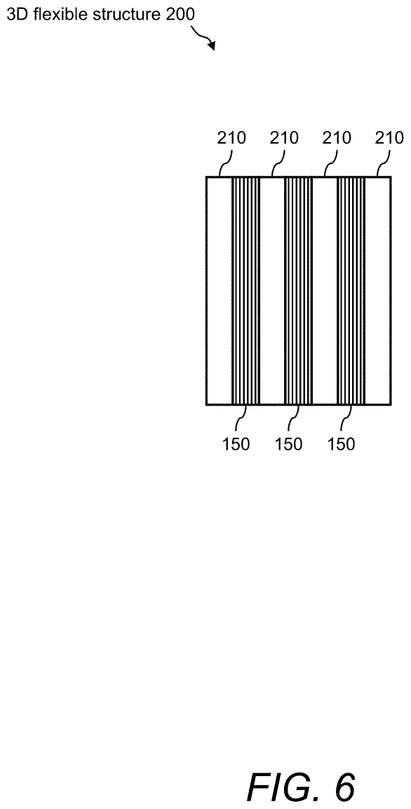

Additionally, 3D flexible structure 200 can be arranged in a horizontal stack. For example, FIG. 6 shows a side view of an example of 3D flexible structure 200 that includes at least one segments of stretchable paper 150 and at least one layer of solid material 210 arranged in a horizontal stack for forming a stretchable and flexible 3D article, such as 3D article 100.

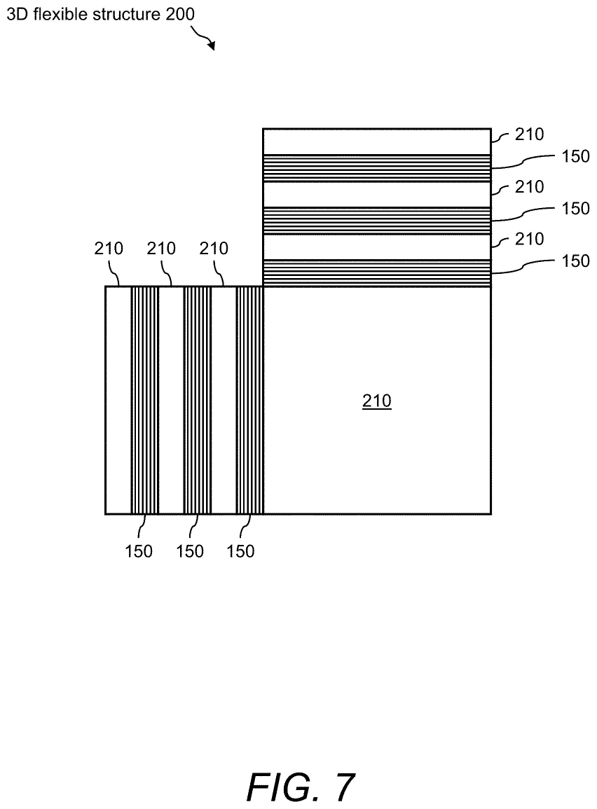

Additionally, 3D flexible structure 200 can be arranged in both a vertical stack and a horizontal stack. For example, FIG. 7 shows a side view of an example of a 3D flexible structure 200 that includes a block of solid material 210. Then, a horizontal stack of at least one segments of stretchable paper 150 and at least one layer of solid material 210 is provided on a side face of the solid material block 210. Then, a vertical stack of at least one segments of stretchable paper 150 and at least one layer of solid material 210 is provided on the top face of the solid material block 210.

The examples of 3D flexible structure 200 shown in FIG. 5A through FIG. 7 can be used to form any type of the presently disclosed 3D article 100, which is any type of stretchable and flexible 3D article.

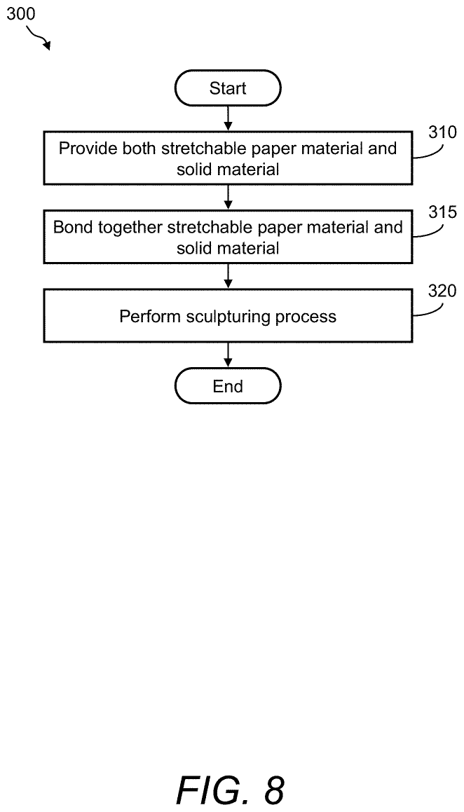

Referring now to FIG. 8 is a flow diagram of an example of a method 300 of making stretchable and flexible 3D articles that include one or more solid portions and at least one folding paper portion, such as 3D article 100. Method 300 may include, but is not limited to, the following steps.

At a step 310, both the stretchable paper material and the solid material is provided. For example, and referring now again to the 3D flexible structures 200 shown in FIG. 5A through FIG. 7, at least one segment of stretchable paper 150 and one layer of solid material 210 is provided.

At a step 315, the stretchable paper material and the solid material are bonded together. For example, and referring now again to the 3D flexible structures 200 shown in FIG. 5A through FIG. 7, the layers of stretchable paper 150 and the layers of solid material 210 are bonded together using an adhesive.

At a step 320, the sculpturing process is performed. For example, using a certain 3D flexible structure 200 shown in FIG. 5A through FIG. 7, a 3D article 100 is formed using standard sculpturing methods and processes.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A three-dimensional (3D) article comprising one or more solid portions and one or more folding paper portions, wherein the one or more solid portions and the one or more folding paper portions are operably attached to form a stretchable and/or flexible 3D article.

2. The 3D article of claim 1, wherein the one or more solid portions and the one or more folding paper portions are arranged in a vertical stack.

3. The 3D article of claim 1, wherein the one or more solid portions and the one or more folding paper portions are arranged in a horizontal stack.

4. The 3D article of claim 1, wherein the one or more solid portions and the one or more folding paper portions are arranged in both a vertical stack and a horizontal stack.

5. The 3D article of claim 1, wherein the article has a closed or unstretched configuration.

6. The 3D article of claim 5, wherein the article has an appearance of a sculpture.

7. The 3D article of claim 1, wherein the article has an open or stretched configuration.

8. The 3D article of claim 7, wherein the article can be opened or retracted with a fluid movement.

9. The 3D article of claim 1, comprising a lower solid portion and an upper solid portion with a folding paper portion sandwiched therebetween.

10. The 3D article of claim 10, wherein the lower solid portion represents a bust of a sculpture and the upper solid portion represents a head of a sculpture.

11. The 3D article of claim 1, wherein the one or more solid portions comprises a material selected from clay, plaster, stone, wood, metal, glass, ceramic, plastic, and combinations thereof.

12. The 3D article of claim 1, wherein the one or more paper portions comprises a material selected from paper, sliced wood, a book, one or more recycled materials, and combinations thereof

13. The 3D article of claim 1, wherein the one or more solid portions and one or more paper portions are operably attached by an adhesive.
